(19) United States
(12) Patent Application Publication
(10) Pub. No.: US 2009/0169756 A1
(43) Pub. Date: Jul. 2, 2009

(54) Paint Strainer System and Method

(76) Inventor: Darrel J. Joosten, Torrance, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/966,982

(22) Filed: Dec. 28, 2007

(51) Int. Cl. B05D 1/02; B05B 7/00

(52) U.S. Cl. 427/421.1; 118/300

(57) ABSTRACT

Systems and methods for painting in which a paint container strainer is held in place with a fastener that exerts strength or force sufficient to keep, hold or restrain the strainer in place, and not fall down into the paint container, during the jostling and other disturbances that typically occur during painting operations.

### FIELD OF INVENTION

The invention relates generally relates to paint strainers, and more specifically to the field of strainers used when painting with paint from a bucket or other container.

### BACKGROUND OF INVENTION

Paint sprayers are in wide spread use to efficiently spray large areas of walls and other surfaces. As described in U.S. Pat. No. 6,436,286 (“the '286 patent”) relatively small apertures found in conventional paint sprayers and the existence of numerous foreign materials, such as particulate, pigment and undissolved resin provide typical sources of clogging in the paint sprayers.

Paint rollers and brushes are also in wide use to paint walls and other surfaces. With respect to painting through with rollers or brushes, such foreign materials, unless strained or filtered from the paint, will become entrained on the roller and then end up on the wall or other surface during the painting process. This of course results in an unacceptable end product because the foreign materials are often visible to the naked eye.

Numerous attempts, such described in the '286 patent, as well as in U.S. Pat. No. 6,736,969 have been made to address the problem of foreign material getting into the paint before or as it is being applied to the desired surface. While many such attempts have provided some solutions or partial solutions to the overall problem, none of those attempts addresses the problem of conventional paint strainer bags frequently falling into the container during normal use. In those situations where a container and a mesh bag of the types shown in the '286 patent are used, the structures and methods employed to hold the bag is place are not adequate, and are the source of significant problems, particularly to professional painters. The present system and method address these problems by providing structures and methods for attaching the strainer to the bucket with enough force to keep it from falling into the paint container during normal use.

### SUMMARY

The systems, structures and methods described herein overcome the drawbacks of known paint strainer systems and methods by providing for secure attachment of the strainer bag to the paint container.

These and other embodiments, features, aspects, and advantages of the present inventive systems will become better understood with regard to the following description, appended claims and accompanying drawings.

### BRIEF DESCRIPTION OF THE DRAWINGS

The foregoing aspects and the attendant advantages of the present paint strainer systems and methods will become more readily appreciated by reference to the following detailed description, when taken in conjunction with the accompanying drawings, wherein:

FIG. 1 is a perspective view of a conventional strainer system and paint container for use in spray or roller type painting;

FIG. 2 is a perspective view of a preferred embodiment strainer system for use in spray or roller type painting;

FIG. 3 is a first end, perspective view of the fastener of the FIG. 2 embodiment;

FIG. 4 is a second end, perspective view of the fastener of the FIG. 2 embodiment;

FIG. 5 is a top perspective view of the fastener of the FIG. 2 embodiment with its top surface removed to illustrate its interior cavity and channeling;

FIG. 6 is a perspective view of an alternate fastener;

FIG. 7 is a perspective view of another alternate fastener;

FIG. 8 is a perspective view of another alternate fastener;

FIG. 9 is a perspective view of another alternate fastener;

FIG. 10 is a perspective view of another alternate fastener.

FIG. 11 is a cross-sectional view of the FIG. 2 system taken along line 11-11.

FIG. 12 is a perspective view of another alternate fastener.

FIG. 13 is a cross-sectional view of the FIG. 12 fastener, taken through line 13-13 of FIG. 12.

FIG. 14 is a cross-sectional view of the FIG. 12 fastener, taken through line 14-14 of FIG. 13.

FIG. 15 is a perspective view of an alternate system, in which the mesh strainer does not have a special hole for accommodating a paint sprayer pick-up tube.

Reference symbols or names are used in the Figures to indicate certain components, aspects or features shown therein. Reference symbols common to more than one Figure indicate like components, aspects or features shown therein.

### DETAILED DESCRIPTION

In accordance with embodiments of the present paint strainer system, various structures are shown attaching a mesh strainer bag to a convention paint bucket with force sufficient to prevent the strainer bag from falling down into the paint filled bucket during normal use.

Although specific embodiments of the invention have been described, various modifications, alterations, alternative constructions, and equivalents are also encompassed within the scope of the invention.

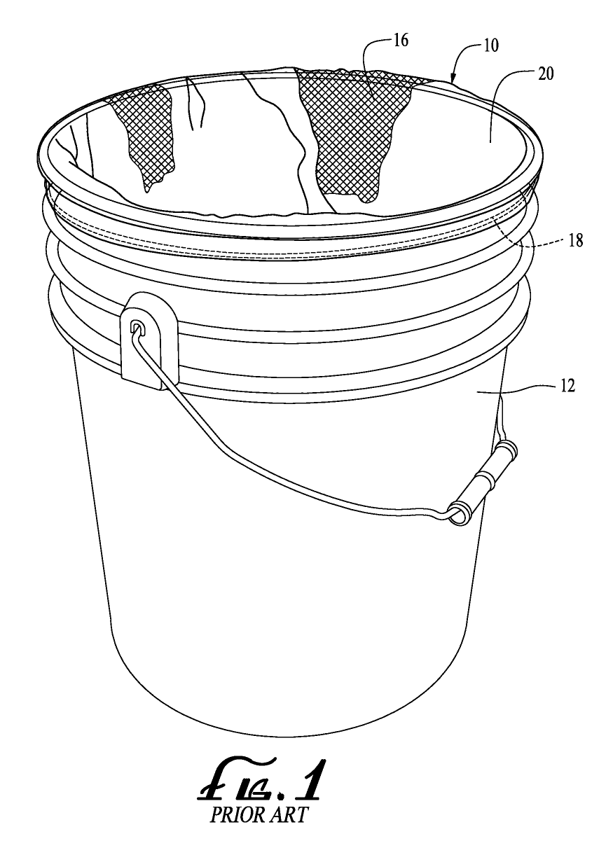

Shown in FIG. 1 is a paint bucket and mesh strainer bag in a conventional paint strainer system, as illustrated for example in the '286 patent. It may be seen that a conventional paint strainer bag 10 is placed in paint container or bucket or pail 12 and it is initially held in place by an elastic material 18 that surrounds an opening 20 of mesh bag 16. As is conventional, the bag 16 is a mesh, with a predetermined mesh size sufficient to filter out undesirable material. It has been discovered that when the bag 16 is held in place by an elastic material, during typical painting operations, the elastic does not exert enough force to hold or retain the mesh strainer in place during normal use. Often the mesh bag will fall into the container, so the entire filtering process is defeated. Then the top part of the mesh strainer typically becomes soaked with paint and the painter or painter's helper must retrieve a wet, paint-soaked bag and attempt re-attach the strainer to the container. Re-attachment attempts require time, and typically are messy. Once the mesh strainer has become soaked with paint it is even more prone to slipping or falling back into the container. Typically, then the painter must hold the wet bag in place, have a helper hold the wet bag in place, or tape the bag in place. Then, paint must be restrained by re-pouring it into the same, or a different bucket. All this takes time and/or additional personnel, ultimately at a cost of time and money. For professional painting jobs, the total cost of multiple instances of paint strainer bags falling into the paint container, and the associated recovery efforts can be significant.

Shown in FIG. 2 is a preferred paint strainer system 30 of the present invention. The system 30 includes a conventional container or bucket 32 having a conventional lip 34, as best illustrated in FIG. 11. These containers are typically plastic or metal and typically hold about 5 gallons of paint. Larger or smaller containers may also be used so long as the container has a lip or equivalent structure at or near the top. A conventional mesh bag 36 is sized, shaped and configured to be placed in and to generally conform to the inner shape of the container 32. Various materials may be used for the bag 36, but nylon or other fine mesh is preferred. The most preferred material and strainer bag is available from Reaves & Co., Durhan, N.C., as its Intex® brand strainer, a 100% nylon/ninon fine mesh bag. Sewn around the top of the bag 36 is, preferably, a hem 38 that defines a channel at the upper end of the bag and in which a drawstring, or cord 40 is positioned. Drawstring 40 may be made of any of many types of materials such as nylon or other synthetic or natural materials. Any specific material of construction for the drawstring or cord may be used, so long as it functions to hold the bag in place as hereinafter described.

Mesh bag 36 may also have an aperture 42 near its top for receiving a pick-up tube (not shown) for a paint sprayer. The outline of the aperture 42 in FIG. 2 is shown by line 44. For systems in which an aperture 42 is used, the aperture is sized to accommodate the pick-tube without adversely affecting the straining function of the bag. For use in painting with brushes or rollers, a pick up tube aperture is not needed and the present system and method encompass strainer bags with, as well as without such apertures.

FIG. 15 illustrates an alternate embodiment system 30, with mesh bag 36, hem 38, drawstring 40 and fastener 46, but without an aperture as shown in FIG. 2. The FIG. 15 embodiment is preferred for those applications in which paint is applied with a brush or a roller, as compared to sprayer. In those applications there is no need for a hole through which a pick-up tube is inserted.

Referring again to FIG. 2, the chord 40 holds the bag 36 in place so that the bag 36 extends down into the container 32, and so that the bag 36 does not slip off of the rim of the bucket during the painting process. The cord 40 in turn is held in place by a fastener, one embodiment of which is shown in FIG. 2 as fastener 46. In general, a fastener capable for use in the present system and method must exert sufficient force on the cord 40 to hold or keep the bag 36 in place during the painting process. Typically, during painting with conventional systems, the paint bucket is moved, kicked or otherwise disturbed with sufficient force to dislodge the paint strainer. Additionally, during normal painting operations, the pick-up tube of the spray painter is moved frequently so as to move the bag 36, and in conventional systems, with enough force to dislodge the strainer. As takes place when the bag is secured to the container by a conventional elastic cord, the jostling and other disturbances of the bag by the pick up tube are sufficient to overcome the restraining force of the elastic and the strainer typically falls into the paint and its container. With a fastener of the present system and method, such as shown in FIGS. 2 and 11, the restraining force exerted on the cord or drawstring 46 is sufficient to keep the cord securely fastened around the top periphery of the container 32 and thus keep the bag 36 in place so that it can perform its straining function despite the jostling and other disturbances.

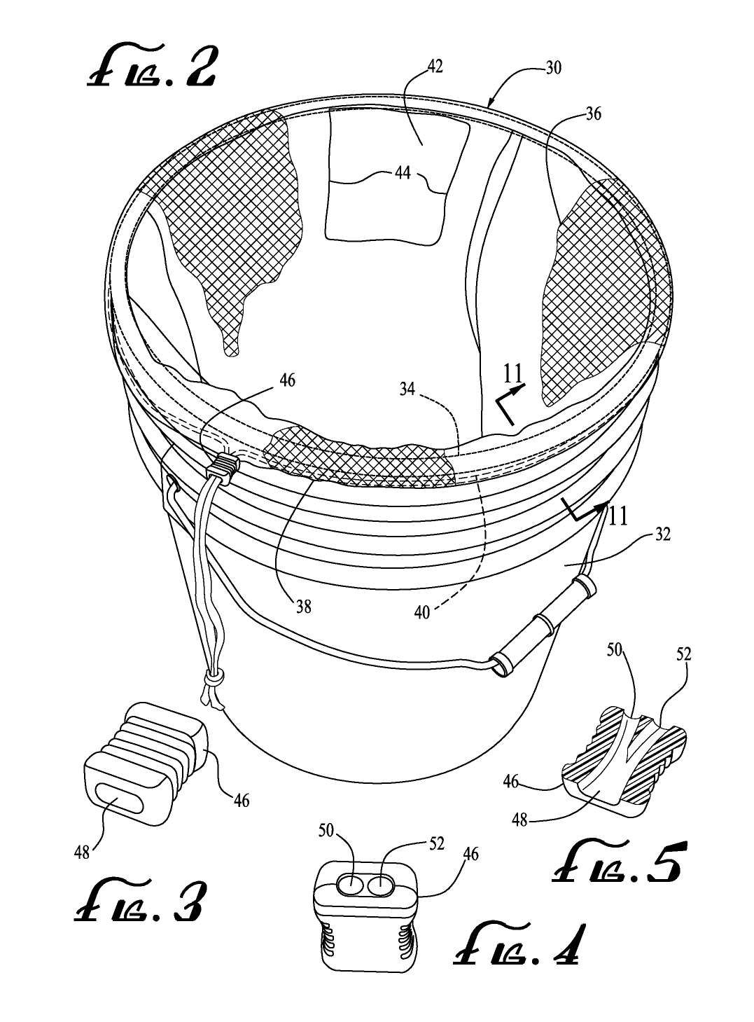

As shown in FIGS. 3-5, a preferred fastener is a rectangular fastener having two apertures at one end, and with the apertures shaped and sized to permit sliding of the cord 40 therethrough, but only with exertion of relatively substantial force. In this context relatively substantial force means force that is needed to overcome the forces that typically would be exerted on a conventional paint strainer bag of the type described herein and exerted during normal use of a paint sprayer during a normal spray painting job. The fastener shown in FIGS. 3-5 is commercially available as a Tetra brand cord fastener, and as typically found on Croakies brand eyewear retainers. As shown best in FIGS. 4 and 5, this preferred fastener 46 is generally rectangular, has an aperture 48 at one end and that extends through a substantial part of its length as a single channel, and then is formed into two relatively narrow apertures 50, 52 at the other end. The dimensions of the apertures and channels are chosen so that pulling the cord through the fastener requires a force greater than that necessary to dislodge the strainer during normal painting operations. Preferably, the fastener 46 is made of a resilient, durable elastomeric material. As will be appreciated, different diameters of cords and fastener apertures may be used. Also, different cross-sectional structures may be used. For example, (not shown) a triangular cross-sectioned, single aperture design would be another alternate design within the scope of the present invention. Similarly, it is not necessary that the apertures be limited to the structures illustrated herein. For example, ratchet-type fasteners may be used in the present system and method, so long as they perform the restraining function described herein.

Referring to FIG. 6, an alternate fastener 54 is shown. The fastener 54 somewhat similarly shaped in that it is generally rectangular, and has two apertures; however, it does not have a cavity in the center that opens into and becomes a single aperture at the other end. Rather it is of a solid construction with the two apertures forming channels that extend through the entire length of its body.

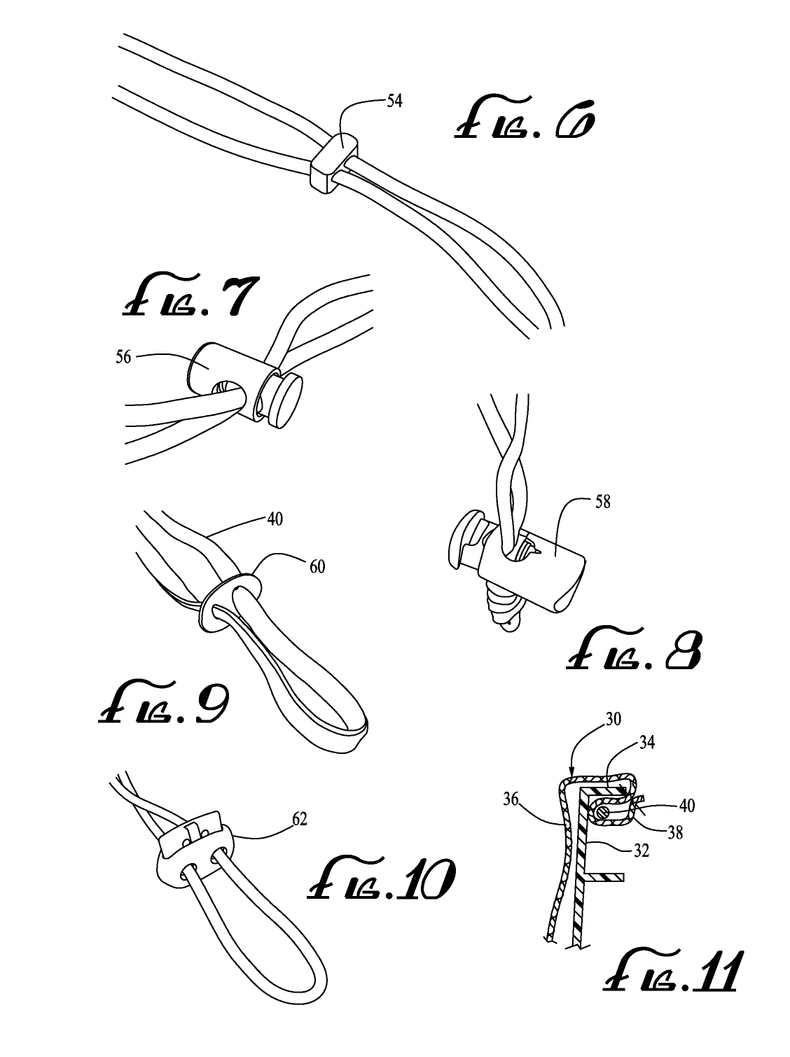

Referring to FIGS. 7-8 two other alternate embodiment fasteners for use in the present system and method are shown. Both are convention, spring-loaded fasteners of the type often found on duffle bags, jackets and other articles. These types of fasteners are typically made of plastic and have spring in the interior. The FIG. 7 fastener 56 is generally of a cylindrical configuration and the FIG. 8 fastener 58 is generally oval in cross section. While the fasteners of the type shown in FIGS. 7-8 function well in the present systems, they are not as preferred as the fastener shown in FIG. 2, due to their size, multiple components and associated cost. Also, the fasteners that have multiple components are prone to malfunction if paint gets inside and thus would be less useful for reuse in comparison to the fastener as shown as 46.

FIG. 9 shows another alternate fastener for use in the present systems. Fastener 60 is a piece of leather that has two apertures though which the drawstring or cord 40 is passed. The apertures in the fastener 60 are sized and shaped so as to fit tightly over the cord 40, and thereby provide sufficient strength and force to keep the bag 36 in place during normal painting operations. Alternate materials in addition to leather could be used, and all such materials are considered to be equivalent so long as they are capable of performing the restraining and retaining function described herein.

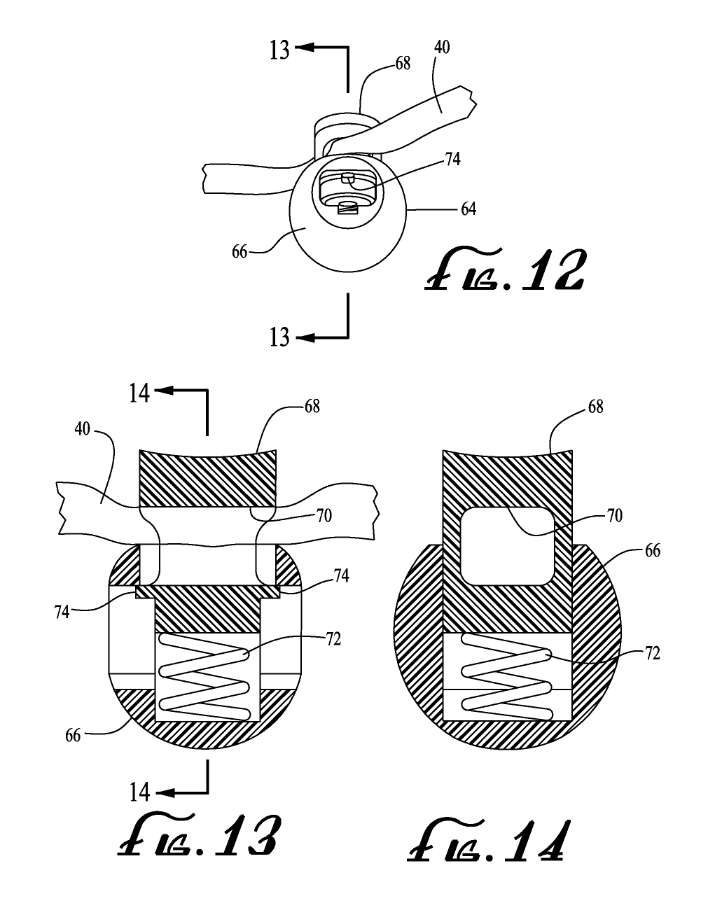

FIG. 10 shows another alternate embodiment fastener 62. Fastener 62 is also a multiple component, spring-loaded fastener that is useful in the present system, but is not preferred due to its size and cost. The fastener 62 is has relatively large operator and the apertures are spaced apart relatively far in comparison to those of fastener 46.

Referring to FIG. 11, a cross-sectional view of the FIG. 2 embodiment is shown to illustrate the restraining or holding function performed by the drawstring or cord 40. Strainer 36 is shown place in the container 32, and with its hem 38 overlying the rim or lip 34 of the container. As described herein, the cord 40 is drawn tightly around the rim of the container, and the fastener exerts sufficient force to keep the cord 40 tightly draw around the rim so that the strainer does not slip back into the container during the jostling and other disturbances that typically occur during normal painting operations.

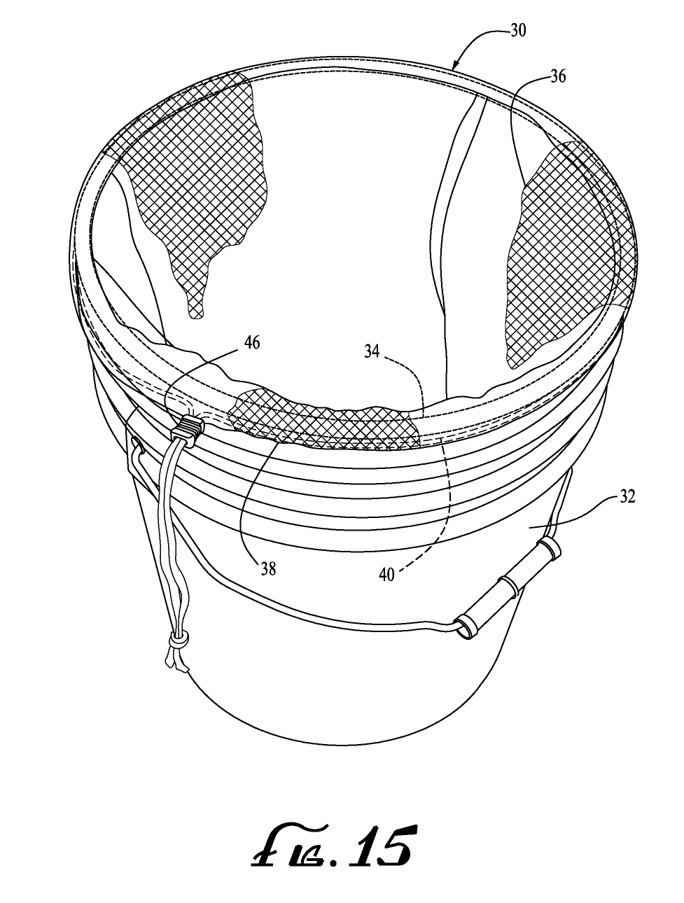

Referring to FIGS. 12-14, yet another preferred fastener 64 for use in the present system and method is used. Fastener 64 has a generally spherical body 66, with an interior body cavity through which plunger or operator 68 operates to hold or release the drawstring 40 that has been passed through the plunger cavity. Spring 72 is positioned inside of the fastener as shown to provide a holding or restraining force sufficient to keep cord 40 pushed against and restrained between the surface 70 of the plunger and the opposed, top edges of the body 66. Stops or shoulders 74 abut against the top edge of the body cavity as shown in FIG. 13.

In a typical professional painting job, first an empty bucket or container is placed on a horizontal surface, and the strainer bag is put into place, as shown in FIG. 2. The fastener is then tightened to hold the strainer bag in place. The fastener of course may be tightened at a later stage in the process, and may be retightened from time to time. However, it is preferred that the fastener be tightened soon after the strainer bag is first placed in the container. The paint from another container is then poured into the container having the strainer bag in place. For a spray painting job the paint pickup tube is placed through the aperture 42. Next the paint sprayer is turned on and painting begins. Because the bag is securely fastened to the container, it does not fall down into the bag during the jostling and other disturbances that typically occur during painting operations. In painting jobs where a brush or roller is used to apply the paint rather than a paint sprayer, no pickup tube is needed and painting preferably begins as soon as the strainer bag has been secured to the container with the fastener. As will be appreciated, the order in which the above steps are performed can be varied.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

I claim:

1. Painting a surface with a paint sprayer and strained paint comprising:
providing a container that is generally cylindrical in cross-section, has a rim at its top end periphery, has a lip near the rim and has a bottom that is generally circular in cross-section;
providing a paint sprayer having a pick-up tube;
providing a strainer;
the strainer being in the form of a mesh bag that has an open end and a closed end;
the strainer being sized, shaped and configured to be placed in and to generally conform to the inner shape of the container;
the strainer having a hem extending around its circumference at its open end and the hem defining a channel;
the strainer including a drawstring positioned in the channel;
the strainer including an aperture positioned near the open end and configured and sized to accommodate the pick-up tube;
the mesh bag having a mesh size sufficient to filter out undesirable material typically found at a painting site, said undesirable material including particulate, paint pigment and undissolved paint resin;
providing a fastener adapted to hold the drawstring in place in the channel near the top periphery of the container and at a pre-determined circumference during normal painting operations;
placing the strainer in the container with the closed end near the container bottom;
positioning the hem and drawstring over the lip and outside of the periphery of the container near its rim;
drawing the drawstring tightly around the top periphery of the container to exert a restraining force on the drawstring sufficient to keep the drawstring securely fastened around the periphery of the container;
placing the pick-up tube through the aperture;
pouring paint into the open end of the strainer prior to or after drawing the drawstring tightly around the top periphery of the container and prior to or after placing the pick-up tube through the aperture;
straining the paint and retaining the strained paint in the container; and,
spraying strained paint on the surface.

2. A painting system comprising:
a paint sprayer and a bucket containing a paint strainer;
the bucket having generally a cylindrical in cross-section, a rim at its top end periphery, a lip near the rim and a bottom;
the paint sprayer having a pick-up tube connected to the paint sprayer with a hose;
the strainer being in the form of a mesh bag;
the bag having an open end, having a closed end and positioned in the bucket;
the bag including an aperture positioned near the open end of the bag and configured and sized to permit through passage of the pick-up tube;
the bag having a hem extending substantially around its circumference at its open end;
the hem defining a channel and the hem having an opening;
a drawstring having a first portion extending through the channel, a second portion extending out of the opening for a predetermined distance and a third portion extending out of the opening for a predetermined distance;
a fastener operatively connected to the drawstring and positioned on the drawstring second portion and on the drawstring third portion;
the mesh bag having a mesh size sufficient to filter out undesirable material typically found at a painting site, said undesirable material including particulate, paint pigment and undissolved paint resin;
the hem and drawstring positioned over the lip and outside of the periphery of the bucket near its rim; and,
the pick-up tube extending through the aperture.

3. The paint strainer system of claim 2 further including the fastener drawn tightly and exerting a restraining force on the drawstring sufficient to keep the drawstring securely fastened around the bucket periphery during normal painting operations.

4. A paint strainer comprising:
a nylon/ninon mesh bag having an open end, a closed end and an aperture positioned near the open end;
the aperture configured and sized to permit through passage of a paint sprayer pick-up tube;
the bag having a hem extending substantially around its open end;
the hem defining a channel and having an opening;
a drawstring having a first portion extending through the channel, a second portion extending out of the opening for a predetermined distance and a third portion extending out of the opening for a predetermined distance;
a fastener operatively connected to the drawstring and positioned on the drawstring second portion and on the drawstring third portion;
the fastener having the capability to exert a restraining force on the drawstring sufficient to keep the drawstring securely fastened around the periphery of a five-gallon bucket having a lip or rim at its top during normal painting operations; and,
the bag having a mesh size sufficient to filter out undesirable material typically found at a painting site, said undesirable material including particulate, paint pigment and undissolved paint resin.

5. The paint strainer of claim 4 in which the fastener has a generally rectangular cross-section.

6. The paint strainer of claim 4 in which the fastener has two apertures at one end, the apertures shaped and sized to accommodate the drawstring and to permit sliding of the drawstring through the apertures only upon application of a pulling force sufficient to overcome forces typically exerted on a conventional paint strainer bag used with commercial paint strainer system.

7. The paint strainer of claim 4 in which the fastener has a single channel extending substantially through its length, the single channel formed into two relatively narrow diameter apertures at one end of the fastener.

8. The painter strainer of claim 4 in which the fastener has a single channel extending substantially through its length, the single channel formed into two apertures at one end of the fastener, and the channel sized to permit pulling of the drawstring through the channel requires application of a pulling force sufficient to overcome forces typically exerted on a conventional paint strainer bag used with a commercial paint strainer system.

9. The painter strainer of claim 4 in which the fastener includes two channels extending through the length of the fastener.

10. The painter strainer of claim 4 in which the fastener is made of a resilient, durable elastomeric material.

11. The painter strainer of claim 4 in which the fastener has a generally triangular cross-section.

12. The painter strainer of claim 4 in which the fastener is spring loaded.

13. The painter strainer of claim 4 in which the fastener is generally of a cylindrical shape.

14. The painter strainer of claim 4 in which the fastener has a generally an oval cross-section.

15. The painter strainer of claim 4 in which the fastener is made of leather.

16. The painter strainer of claim 4 in which the fastener is made of leather and includes two apertures sized to fit tightly over the drawstring with a force to keep the bag in place in the bucket.
